(19) United States
(12) Patent Application Publication
(10) Pub. No.: US 2012/0051452 A1
(43) Pub. Date: Mar. 1, 2012

(54) MODIFIED CODED HYBRID SUBCARRIER AMPLITUDE PHASE POLARIZATION MODULATION

(75) Inventors: Ivan B. Djordjevic, Tucson, AZ (US); Lei Xu, Princeton Junction, NJ (US); Ting Wang, Princeton, NJ (US)

(73) Assignee: NEC Laboratories America, Inc., Princeton, NJ (US)

(21) Appl. No.: 12/873,915

(22) Filed: Sep. 1, 2010

(51) Int. Cl. H04L 27/00; H04L 27/06

(52) U.S. Cl. 375/295; 375/341

(57) ABSTRACT

Methods and systems for optical communication using hybrid subcarrier/amplitude/phase/polarization modulation are shown that include LDPC encoding a plurality of groups of bitstreams. The groups of bitstreams are mapped to the points of a three-dimensional constellation that is represented by the vertices of a regular polyhedron and its dual. Each group of bitstreams is then modulated onto a respective subcarrier beam and the subcarrier beams are combined into a carrier beam using a power combiner.

### BACKGROUND

1. Technical Field

The present invention relates to optical transmission and, more particularly, to systems and methods for three-dimensional modulation in optical transmission systems.

2. Description of the Related Art

Achieving optical transmission beyond 100 Gb/s per wavelength has become the interest of many research groups in the last several years. This interest stems from the fact that the demand on transmission capacities is continuously increasing, due to the increasing popularity of the Internet and multimedia. The major concerns while adapting to higher transmission rates are dealing with signal quality degradation due to various linear and non-linear effects and escalating costs.

### SUMMARY

A method for transmitting is shown that includes LDPC encoding a plurality of groups of bitstreams. The groups of bitstreams are mapped to the points of a three-dimensional constellation that is represented by the vertices of a regular polyhedron and its dual. Each group of bitstreams is modulated onto a respective subcarrier beam. The subcarrier beams are combined into a carrier beam using a power combiner for transmission over optical fiber.

A method for receiving for receiving is shown that includes splitting a carrier beam into subcarriers using a power splitter. The subcarriers are then split into orthogonal polarizations. Data is detected in the subcarriers and then demodulated to extract data symbols. The symbols are demapped according to a three-dimensional constellation that is represented by the vertices of a regular polyhedron and its dual to produce symbol log-likelihood ratios (LLRs). The symbol LLR blocks are used to calculate bit LLRs which are, in turn, used to LDPC decode transmitted information.

A transmitter is shown that includes a plurality of hybrid amplitude phase polarization (HAPP) modulators configured to transmit a group of bitstreams on a subcarrier beam and a power combiner configured to combine the subcarrier beams into a single carrier beam for transmission. Each HAPP modulator includes a plurality of LDPC encoders configured to LDPC encode each bitstream in the group of bitstreams, a mapper configured to map the groups of bitstreams to the points of a three-dimensional constellation that is represented by the vertices of a regular polyhedron and its dual, and a modulator configured to amplitude modulate, phase modulate, and polarization multiplex information from the bitstreams onto the subcarrier beam.

A receiver is shown that includes a power splitter configured to split a carrier beam into a plurality of subcarrier beams having different frequencies and a plurality of hybrid amplitude phase polarization (HAPP) demodulators configured to extract a group of bitstreams from a subcarrier beam. The HAPP demodulators each include a polarization beam splitter configured to split the subcarrier beam into two orthogonal polarizations. Two demodulators extract data symbols from the orthogonal polarizations and a demapper demaps the symbols according to a three-dimensional constellation that is represented by the vertices of a regular polyhedron and its dual to produce symbol log-likelihood ratios (LLRs). A bit LLR calculation module is configured to calculate bit LLRs based on the symbol LLRs and a plurality of LDPC decoders configured to decode transmitted information using the bit LLRs.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows a block diagram of a hybrid subcarrier/amplitude/phase/polarization (H-SAPP) communication system.

FIG. 2 shows a block diagram of a hybrid amplitude/phase/polarization (HAPP) transmitter.

FIG. 3 shows a block diagram of an HAPP modulator.

FIG. 4 shows a block diagram of an HAPP receiver.

FIG. 5a shows a 3-D constellation for a dodecahedron.

FIG. 5b shows a 3-D constellation for a dodecahedron that is divided into two sets of vertices.

FIG. 6a shows a 3-D constellation for an icosahedron.

FIG. 6b shows a 3-D constellation for an icosahedron that is divided into two sets of vertices.

FIG. 7 shows a block/flow diagram of a method for H-SAPP transmission.

FIG. 8 shows a block/flow diagram of a method for HAPP modulation.

FIG. 9 shows a block/flow diagram for H-SAPP reception.

### DETAILED DESCRIPTION OF PREFERRED EMBODIMENTS

A modified hybrid subcarrier/amplitude/phase/polarization (H-SAPP) modulation scheme is composed of three or more HAPP subsystems modulated with different subcarriers that are multiplexed together. At any symbol rate and code rate, H-SAPP is capable of achieving the aggregate rate of the individual HAPP systems it is composed of, without introducing any bit-error ratio (BER) performance degradation, as long as the orthogonality among subcarriers is preserved. However, perfect orthogonality is difficult to achieve. As such, if the constellations used by the subcarriers are too similar, there can be cross-talk which substantially decreases the performance of the system. Modified H-SAPP increases the potential of the H-SAPP in a three-dimensional space by including both the regular polyhedron and its dual in a single constellation system. By using a constellation that includes a polyhedron and its dual, the present principles advantageously take full advantage of the potential of 3-dimensional space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

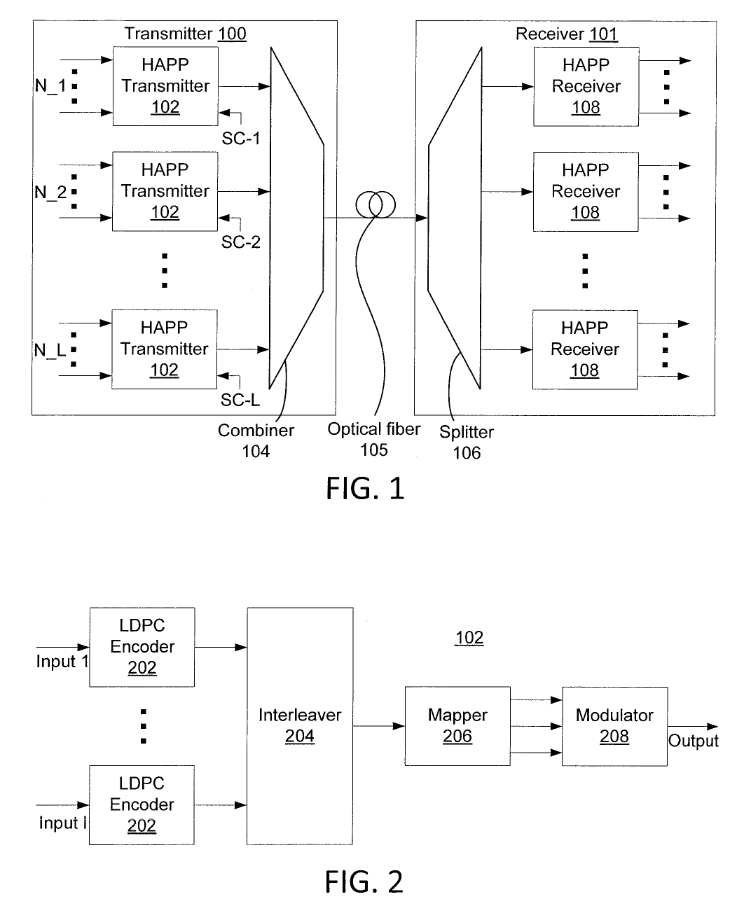

Referring now to the drawings in which like numerals represent the same or similar elements and initially to FIG. 1, an H-SAPP optical transmission system is shown. An H-SAPP transmitter 100 includes L HAPP transmitters 102, each of which receives a set of input bit streams. The transmitters 102 modulate the input data streams onto unique optical subcarriers which are combined into a single carrier beam in power combiner 104. The carrier beam is transmitted over an optical fiber and received at H-SAPP receiver 101. The arrier beam is split into its constituent subcarriers at splitter 106, with each subcarrier going to a respective HAPP receiver 108. The HAPP receivers demodulate the subcarriers and produce their respective sets of output streams.

H-SAPP is advantageously capable of exploiting the full potential of the 3-dimensional space. H-SAPP increases the minimum distance between the constellation points in comparison to 2-dimensional quadrature amplitude modulation (QAM) counterparts which leads to improving the BER performance of the overall system. Increasing the space between constellation points achieves this goal by making it more difficult for noise fluctuations to move a received signal from one constellation point to another. By further including the dual of a constellation polyhedron, the present principles allow for a significant increase in efficiency.

In comparison with HAPP systems, H-SAPP allows a non-power-of-two constellation to be utilized, such as 20-point H-SAPP. This is achieved by including different subcarriers, e.g., by combining a 16-HAPP subcarrier with a 4-HAPP subcarrier. The HAPP modulation format is based on regular polyhedrons inscribed inside a Poincaré sphere, such that the vertices of the polyhedrons touch the surface of the sphere. Since simple regular polyhedrons are not flexible in terms of number of vertices and number of faces (indeed, there are only nine kinds of mathematically possible regular polyhedrons), the number of points per constellation becomes limited. This is especially so since the total constellation has to have a number of points that is a power of 2 for binary systems. For that matter, H-SAPP offers a more flexible utilization of the advantageous mathematical properties of these polyhedrons as it allows the combination of different polyhedrons—thereby permitting constellations that can be effectively used for communications.

Modified H-SAPP is composed of two or more HAPP subsystems modulated with different subcarriers, each having a frequency that is orthogonal with respect to the others. In an H-SAPP or a modified H-SAPP system, N input bit streams from different information sources are divided into L groups with a variable number of streams per group. These groups are designated in FIG. 1 as N₁, N₂, . . . , N_{L}. The selection process for the different groups N₁, N₂, . . . , N_{L} is governed by two factors: the desired aggregate rate, and the polyhedron of choice. Each set of N₁ (the number of streams in the l′ group) is then used as input to a HAPP transmitter 102, where it is modulated with a unique subcarrier. One embodiment that will be discussed herein is a 32-H-SAPP system configuration where N=11 and L=4. N₁, N₂, N₃ and N₄ are 4, 2, 2 and 3, producing in turn subcarriers that use 16-HAPP, 4-HAPP, 4-HAPP, and 8-HAPP respectively. N₁ and N₂ in combination represent a dodecahedron of 20 vertices and 12 faces, while N₃ and N₄ in combination represent the dual icosahedron of 12 vertices. This example is not meant to be limiting, but is instead used for the purpose of illustration. The number of groups, the number of information sources per group, and the polyhedrons used may vary.

Referring now to FIG. 2, a detailed view of HAPP transmitter 102 is shown. N₁ input streams arrive at N₁ low-density parity check (LDPC) encoders 202. The LPDC encoders 202 use structured LDPC codes, described for the sake of simplicity as being identical, with a code rate r=k/n, where k represents the number of information bits and n represents the codeword length. As shown in FIG. 2, the outputs of the encoders 202 are interleaved by an N₁×n bit-interleaver where the sequences are written row-wise and read column-wise.

The output of the interleaver is sent N₁ bits at every time instant i to a mapper 206. The mapper 206 maps each N₁ bits into a 2^{N}^{₁}-ary signal constellation point. The mapping is then retrieved from a lookup table, wherein the constellation points are based on a vertex of a polyhedron inscribed in a Poincaré sphere, as will be described in greater detail below. The ensemble of all the vertices of the HAPP systems 102 forms the vertices of the regular polyhedron and its dual in a modified H-SAPP constellation. The signal from the mapper 206 is then modulated by the HAPP modulator 208.

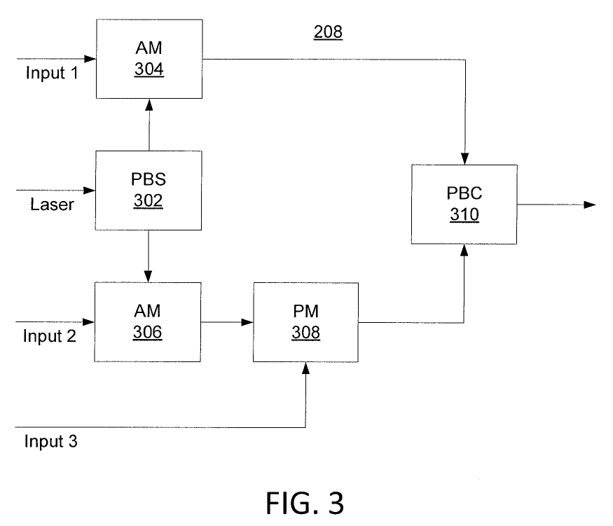

Referring now to FIG. 3, a detailed view of the HAPP modulator 208 is shown. Three input voltages are produced by mapper 206 and are used to control the modulator. A laser beam is split into two orthogonal polarizations at polarizing beam splitter 302. These two polarized beams are formed at the subcarrier frequency for the particular HAPP transmitter 102. One beam is passed to amplitude modulator (AM) 304 and the other is passed to AM 306. AMs 304 and 306 receive control signals that are generated by mapper 206 and modulate the orthogonally polarized beams with those signals. The output of AM 306 passes to phase modulator (PM) 308, which receives the third control signal and phase modulates the polarized beam. The two orthogonally polarized beams are then combined at polarized beam combiner 310 to produce an amplitude-modulated, phase-modulated, polarization-multiplexed subcarrier signal.

As noted above, the mapper 206 maps input bits to the vertices of polyhedrons that are inscribed in a Poincaré sphere. As such, Stokes parameters are used to define the coordinates of the vertices, as the Poincaré sphere is a parameterization of three of the fours Stokes parameters: s₁, s₂, and s₃. The Stokes parameters for the present case are defined as:

s₁=αₓ²−α_{y}²

s₂=2αₓα_{y} cos(δ)

s₃=2αₓα_{y} sin(δ)

δ=φₓ−φ_{y} (1)

where

Eₓ(t)=αₓ(t)e^{j[αN+φ}^{ₓ}^{(t)]}

E_{y}(t)=α_{y}(t)e^{j[αN+φ}^{_{y}}^{(t)]}. (2)

The variables s₁, s₂, and s₃ represent the coordinates on the Poincaré sphere, αₓ and α_{y} represent amplitudes in x- and y-polarizations, respectively; δ represents the phase difference of signals transmitted in orthogonal polarization, and φₓ and φ_{y} represent the phases of signals transmitted in x- and y-polarization, respectively. For equations (2), Eₓ and E_{y} represent electrical fields in x- and y-polarizations (ω denotes the transmitting laser frequency). Eₓ and E_{y} are expressed as functions with respect to time t.
It can be assumed that φₓ=0 at all times, hence δ=−φ_{y}. This yields a system of three equations with three unknowns. Using symmetrical geometric shapes inscribed on the sphere results in closed form numbers for the voltages as shown in Table 1 below. Table 1 is the lookup table for 8-HAPP and defines the symbols.

TABLE 1

| Inter- | | | | | | |
|---|---|---|---|---|---|---|
| leaver | | | | | | |
| Out- | | | | | | |
| put | s₁ | s₂ | s₃ | δ | aₓ | a_{y} |
| 000 | 1/\sqrt{3} | 1/\sqrt{3} | 1/\sqrt{3} | π/4 | $\sqrt{\frac{1}{2} ( 1 + \frac{1}{\sqrt{3}} )}$ | $\sqrt{\frac{1}{2} ( 1 - \frac{1}{\sqrt{3}} )}$ |
| 001 | 1/\sqrt{3} | 1/\sqrt{3} | −1/\sqrt{3} | −π/4 | $\sqrt{\frac{1}{2} ( 1 + \frac{1}{\sqrt{3}} )}$ | $\sqrt{\frac{1}{2} ( 1 - \frac{1}{\sqrt{3}} )}$ |
| 010 | 1/\sqrt{3} | −1/\sqrt{3} | 1/\sqrt{3} | 3π/4 | $\sqrt{\frac{1}{2} ( 1 + \frac{1}{\sqrt{3}} )}$ | $\sqrt{\frac{1}{2} ( 1 - \frac{1}{\sqrt{3}} )}$ |
| 011 | 1/\sqrt{3} | −1/\sqrt{3} | −1/\sqrt{3} | −3π/4 | $\sqrt{\frac{1}{2} ( 1 + \frac{1}{\sqrt{3}} )}$ | $\sqrt{\frac{1}{2} ( 1 - \frac{1}{\sqrt{3}} )}$ |
| 100 | −1/\sqrt{3} | 1/\sqrt{3} | 1/\sqrt{3} | π/4 | $\sqrt{\frac{1}{2} ( 1 - \frac{1}{\sqrt{3}} )}$ | $\sqrt{\frac{1}{2} ( 1 + \frac{1}{\sqrt{3}} )}$ |
| 101 | −1/\sqrt{3} | 1/\sqrt{3} | −1/\sqrt{3} | −π/4 | $\sqrt{\frac{1}{2} ( 1 - \frac{1}{\sqrt{3}} )}$ | $\sqrt{\frac{1}{2} ( 1 + \frac{1}{\sqrt{3}} )}$ |
| 110 | −1/\sqrt{3} | −1/\sqrt{3} | 1/\sqrt{3} | 3π/4 | $\sqrt{\frac{1}{2} ( 1 - \frac{1}{\sqrt{3}} )}$ | $\sqrt{\frac{1}{2} ( 1 + \frac{1}{\sqrt{3}} )}$ |
| 111 | −1/\sqrt{3} | −1/\sqrt{3} | −1/\sqrt{3} | −3π/4 | $\sqrt{\frac{1}{2} ( 1 - \frac{1}{\sqrt{3}} )}$ | $\sqrt{\frac{1}{2} ( 1 + \frac{1}{\sqrt{3}} )}$ |

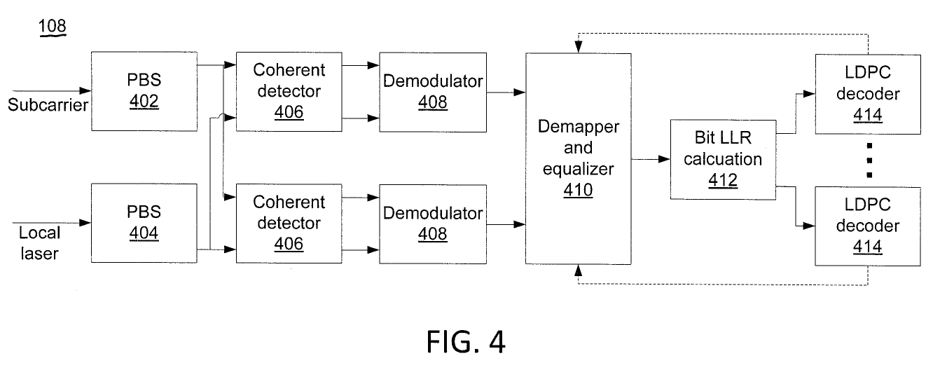

Referring now to FIG. 4, a diagram of an HAPP receiver 108 is shown. The HAPP receiver 108 receives a subcarrier beam at a particular frequency. The subcarrier beam arrives at polarizing beam splitter 402, which splits the carrier beam into orthogonally polarized beams and passes the polarized beams to coherent detectors 406. A local laser is similarly split at polarizing beam splitter 404 passes to the same detectors 406. The detectors produce two outputs each that provide all of the information needed to extract amplitudes and phases for both polarizations.

These four signals are passed to demodulators 408, which extract symbols from the information that was modulated onto the subcarrier. Block 410 performs demapping as well as performing equalization based on a multi-level Bahl-Cocke-Jelinek-Raviv (BCJR) algorithm, though other equalization algorithms could be used instead or in addition. The demapper 410 may be an a posteriori probability (APP) demapper. The output of the demapping/equalizing block is forwarded to bit log-likelihood ratio (LLR) calculator 412 which provides the LLRs that are used in LDPC decoding at LDPC decoders 414.

Extrinsic information is then iterated back and forth between the LDPC decoders 414 and the equalizer 410 until achieving convergence or a predefined maximum number of iterations is reached. This process is referred to as “outer iterations” and is distinct from the “inner iterations” that take place within the LDPC decoders 414 themselves. Outer iterations help in reducing the BER at the input of the LDPC decoders 414 so that they can efficiently decode data within a small, predefined number of inner iterations without increasing the complexity of the system.

One particular implementation of the present principles can be seen in an exemplary 32-H-SAPP embodiment. Table 2 describes the lookup table for a 32-H-SAPP constellation that is based on a dodecahedron and its dual icosahedron. This configuration uses four subcarriers, two of which are used to modulate the points of the dodecahedron vertices, and the other two being used to modulate the vertices of the icosahedrons. As shown in the table, there are four groups, labelled N₁, N₂, N₃, and N₄, the first of which maps the input from the first four bitstreams onto sixteen of the twenty vertices in the constellation dodecahedron. The second group maps the input of two bitstreams onto the four vertices that form a tetrahedron. The selection of vertices for a subcarrier is done to maximize the distance between the points on that subcarrier in order to maximize the BER benefits when subcarrier orthogonality is not perfect.

TABLE 2

| Interleaver Group output s₁ s₂ s₃ | Interleaver Group output s₁ s₂ s₃ |
|---|---|
| ${N}_{1} \{ \begin{matrix}0000 & 1 / \sqrt{3} & 1 / \sqrt{3} & 1 / \sqrt{3} \\ 0001 & 1 / \sqrt{3} & 1 / \sqrt{3} & - 1 / \sqrt{3} \\ 0010 & 1 / \sqrt{3} & - 1 / \sqrt{3} & 1 / \sqrt{3} \\ 0011 & 1 / \sqrt{3} & - 1 / \sqrt{3} & - 1 / \sqrt{3} \\ 0100 & - 1 / \sqrt{3} & 1 / \sqrt{3} & 1 / \sqrt{3} \\ 0101 & - 1 / \sqrt{3} & 1 / \sqrt{3} & - 1 / \sqrt{3} \\ 0110 & - 1 / \sqrt{3} & - 1 / \sqrt{3} & 1 / \sqrt{3} \\ 0111 & 0 & 1 / \sqrt{3} d & d / {\sqrt{3}}^{*} \\ 1000 & 0 & 1 / \sqrt{3} d & - d / \sqrt{3} \\ 1001 & 0 & - 1 / \sqrt{3} d & - d / \sqrt{3} \\ 1010 & 1 / \sqrt{3} d & d / \sqrt{3} & 0 \\ 1011 & 1 / \sqrt{3} d & - d / \sqrt{3} & 0 \\ 1100 & - 1 / \sqrt{3} d & - d / \sqrt{3} & 0 \\ 1101 & d / \sqrt{3} & 0 & 1 / \sqrt{3} d \\ 1110 & - d / \sqrt{3} & 0 & 1 / \sqrt{3} d \\ 1111 & - d / \sqrt{3} & 0 & - 1 / \sqrt{3} d\end{matrix}$ | ${N}_{2} \{ \underline{\begin{matrix}00 & 0 & - 1 / \sqrt{3} d & d / \sqrt{3} \\ 01 & d / \sqrt{3} & 0 & - 1 / \sqrt{3} d \\ 10 & - 1 / \sqrt{3} & - 1 / \sqrt{3} & - 1 / \sqrt{3} \\ 11 & - 1 / \sqrt{3} d & d / \sqrt{3} & 0\end{matrix}}$ ${N}_{3} \{ \underline{\begin{matrix}00 & 0 & 1 / \sqrt{3} & d / \sqrt{3} \\ 01 & 0 & 1 / \sqrt{3} & - d / \sqrt{3} \\ 10 & 0 & - 1 / \sqrt{3} & d / \sqrt{3} \\ 11 & 0 & - 1 / \sqrt{3} & - d / \sqrt{3}\end{matrix}}$ ${N}_{4} \{ \begin{matrix}000 & 1 / \sqrt{3} & d / \sqrt{3} & 0 \\ 001 & 1 / \sqrt{3} & - d / \sqrt{3} & 0 \\ 010 & - 1 / \sqrt{3} & d / \sqrt{3} & 0 \\ 011 & - 1 / \sqrt{3} & - d / \sqrt{3} & 0 \\ 100 & d / \sqrt{3} & 0 & 1 / \sqrt{3} \\ 101 & d / \sqrt{3} & 0 & - 1 / \sqrt{3} \\ 110 & - d / \sqrt{3} & 0 & 1 / \sqrt{3} \\ 111 & - d / \sqrt{3} & 0 & - 1 / \sqrt{3}\end{matrix}$ |

In Table 2, group N₁ corresponds to 16-HAPP and group N₂ corresponds to 4-HAPP. To increase the total rate of the system, the icosahedron is formed by the third and fourth streams. The third group, N₃, maps the input from two bitstreams onto four points of the twelve vertices of the icosahedrons, while group N₄ maps the input of the remaining three bitstreams onto the remaining eight vertices. In Table 2, group N₃ corresponds to another 4-HAPP, and group N₄ corresponds to an 8-HAPP. The constellations for the four subcarriers results in a 32-H-SAPP constellation that uses an 11-bit input. d denotes the golden ratio (1+√5)/2.

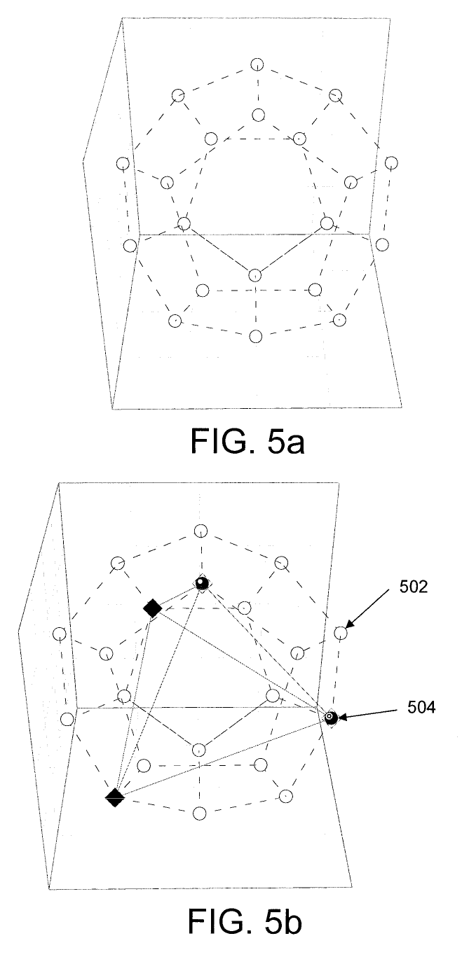

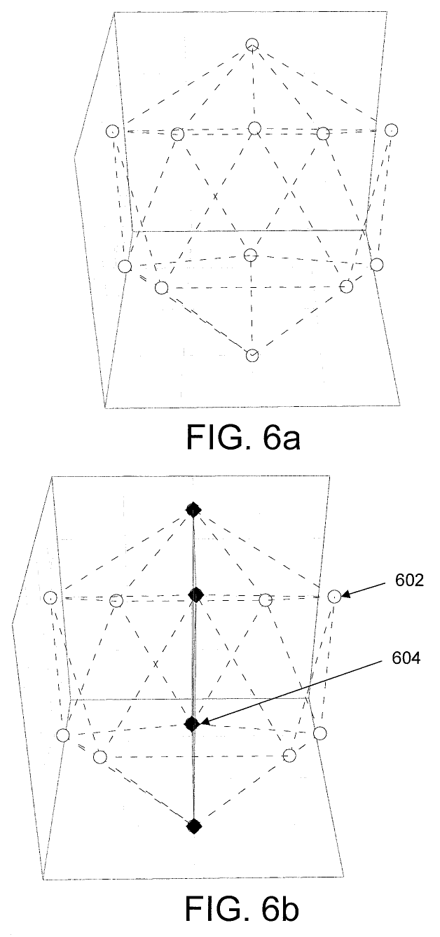

Referring now to FIGS. 5a and 5b, a dodecahedron is shown representing the 20-S-HAPP system formed by groups N₁ and N₂. The total system is shown in FIG. 5a, whereas FIG. 5b differentiates between the points defined by group N₁ 502, which are shown as open circles connected by dotted lines, and the points defined by group N₂ 504, which are shown as filled circles, connected by solid lines. Referring to FIGS. 6a and 6b, the dual icosahedron that represents the remaining 12-S-HAPP system is shown. Again, FIG. 6a shows the total system, whereas FIG. 6b differentiates between the eight points provided by group N₃ 602, shown as open circles connected by dotted lines, and the four points provided by group N₄ 604, shown as filled circles connected by solid lines. When the constellations shown in FIGS. 5 and 6 are used together, they produce a 32-H-SAPP system.

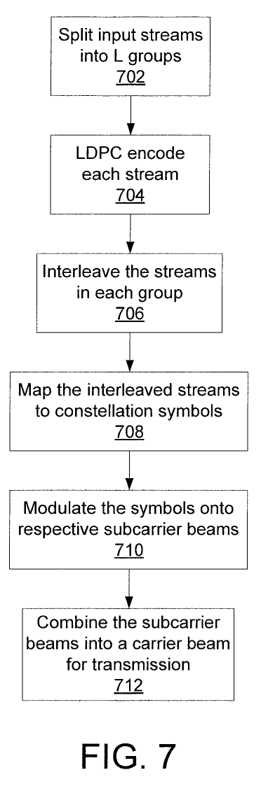

Referring now to FIG. 7, a method for communication via LDPC-coded H-SAPP modulation is shown. Input streams are split into L groups at block 702 and each stream is LDPC encoded at block 704. The bitstreams in each group are then interleaved together at block 706. The interleaved streams are mapped to constellation symbols at block 708. These symbols are modulated onto subcarrier beams at block 712, thereby creating a set of L subcarrier beams operating at orthogonal frequencies. At block 712 the subcarriers are combined into a single carrier beam for transmission.

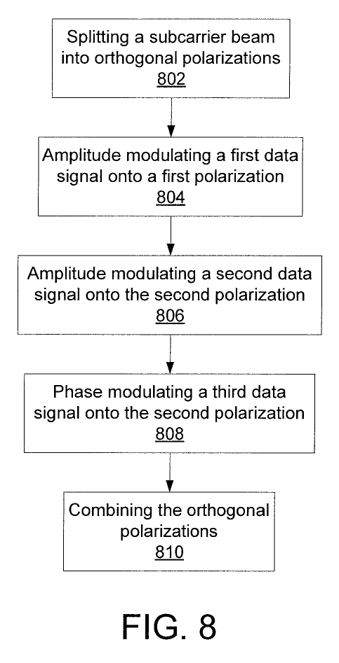

Referring now to FIG. 8, a method for HAPP modulation is shown. A subcarrier beam is split at block 802 into two orthogonal polarizations. At block 804, a first data signal is amplitude modulated onto the first of the orthogonal polarizations. At block 806, a second data signal is amplitude modulated on the second of the orthogonal polarizations. Block 808 further phase modulates a third data signal onto the second polarization before block 810 combines the orthogonal polarizations into a single subcarrier that has been HAPP modulated.

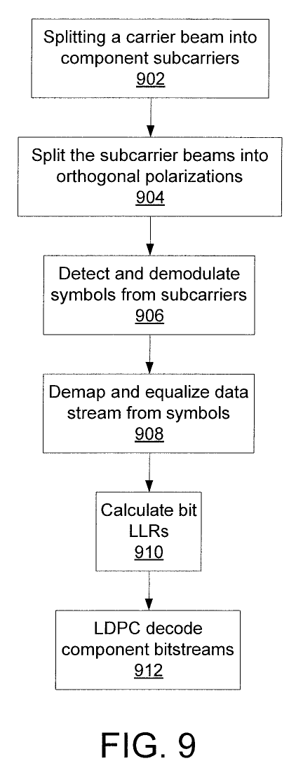

Referring now to FIG. 9, a method for receiving H-SAPP modulated is shown. A carrier beam is received and split into component orthogonal subcarriers at block 902. Each subcarrier beam is split into orthogonal polarizations at block 904. Block 906 then detects and demodulates the symbols from the polarizations, producing a stream of constellation symbols. Block 908 demaps and equalizes the symbols, producing an encoded bitstream. Block 910 calculates bit LLRs to be used in LDPC decoding at block 912.

The present principles enable optical transmission beyond 400 Gb/s in aggregate rate. Modulation and coding are performed in a manner that allows the transmission signal processing, detection, and decoding to be done at much lower symbol rates, where dealing with non-linear effects is more convenient. As such, escalating costs are avoided.

Having described preferred embodiments of a system and method for LDPC-coded H-SAPP modulation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for transmitting, comprising:
LDPC encoding a plurality of groups of bitstreams;
mapping the groups of bitstreams to the points of a three-dimensional constellation that is represented by the vertices of a regular polyhedron and its dual;
modulating each group of bitstreams onto a respective subcarrier beam; and
combining the subcarrier beams into a carrier beam using a power combiner.

2. The method of claim 1, wherein the points of the constellation correspond to the vertices of a dodecahedron and an icosahedron.

3. The method of claim 2, wherein the constellation is a 32-point hybrid subcarrier amplitude phase polarization modulation (H-SAPP) constellation.

4. The method of claim 3, wherein a first group of bitstreams is mapped to sixteen vertices of a dodecahedron, a second group of bitstreams is mapped to the remaining vertices of the dodecahedron, a third group of bitstreams is mapped to eight vertices of a icosahedron, and a fourth group of bitstreams is mapped to the remaining vertices of the icosahedron.

5. The method of claim 1, wherein said modulating comprises:
splitting a laser beam into orthogonal polarizations;
amplitude modulating information from the group of bitstreams onto each of the polarizations;
phase modulating information from the group of bitstreams onto one of the polarizations;
combining the orthogonal polarizations into the subcarrier beam.

6. A method for receiving, comprising:
splitting a carrier beam into subcarriers using a power splitter;
splitting each subcarrier into orthogonal polarizations;
detecting data in the subcarriers;
demodulating the subcarriers to extract data symbols;
demapping the symbols according to a three-dimensional constellation that is represented by the vertices of a regular polyhedron and its dual to produce symbol log-likelihood ratios (LLRs);
calculating bit LLRs based on the symbol LLRs; and
LDPC decoding transmitted information using the bit LLRs.

7. The method of claim 6, wherein the points of the constellation correspond to the vertices of a dodecahedron and an icosahedron.

8. The method of claim 7, wherein the constellation is a 32-point hybrid subcarrier amplitude phase polarization modulation (H-SAPP) constellation.

9. The method of claim 8, wherein a first group of bitstreams is mapped to sixteen vertices of a dodecahedron, a second group of bitstreams is mapped to the remaining vertices of the dodecahedron, a third group of bitstreams is mapped to eight vertices of a icosahedron, and a fourth group of bitstreams is mapped to the remaining vertices of the icosahedron.

10. The method of claim 6, further comprising equalizing symbols using extrinsic information generated by said LDPC decoding.

11. A transmitter, comprising:
a plurality of hybrid amplitude phase polarization (HAPP) modulators configured to transmit a group of bitstreams on a subcarrier beam, each comprising:
a plurality of LDPC encoders configured to LDPC encode each bitstream in the group of bitstreams;
a mapper configured to map the groups of bitstreams to the points of a three-dimensional constellation that is represented by the vertices of a regular polyhedron and its dual; and
a modulator configured to amplitude modulate, phase modulate, and polarization multiplex information from the bitstreams onto the subcarrier beam; and
a power combiner configured to combine the subcarrier beams into a single carrier beam for transmission.

12. The transmitter of claim 11, wherein the points of the constellation correspond to the vertices of a dodecahedron and an icosahedron.

13. The transmitter of claim 12, wherein the constellation is a 32-point hybrid subcarrier amplitude phase polarization modulation (H-SAPP) constellation.

14. The transmitter of claim 13, wherein a first group of bitstreams is mapped to sixteen vertices of a dodecahedron, a second group of bitstreams is mapped to the remaining vertices of the dodecahedron, a third group of bitstreams is mapped to eight vertices of a icosahedron, and a fourth group of bitstreams is mapped to the remaining vertices of the icosahedron.

15. The transmitter of claim 11, wherein the modulator comprises:
a polarization beam splitter configured to split the subcarrier beam into two orthogonal polarizations;
a first amplitude modulator configured to amplitude modulate information from the bitstreams onto a first polarization;
a second amplitude modulator configured to amplitude modulate information from the bitstreams onto a second polarization;
a phase modulator configured to phase modulate information from the bitstreams onto the second polarization; and
a polarization beam combiner configured to combine the orthogonal polarizations into a modulated subcarrier beam.

16. The transmitter of claim 11, wherein the mapper comprises a lookup table configured to convert between a Stokes representation and Cartesian/polar coordinates in two orthogonal polarizations.

17. A receiver, comprising:
a power splitter configured to split a carrier beam into a plurality of subcarrier beams having different frequencies; and
a plurality of hybrid amplitude phase polarization (HAPP) demodulators configured to extract a group of bitstreams from a subcarrier beam, each comprising:
a polarization beam splitter configured to split the subcarrier beam into two orthogonal polarizations;
two demodulators configured to extract data symbols from the orthogonal polarizations;
a demapper configured to demap the symbols according to a three-dimensional constellation that is represented by the vertices of a regular polyhedron and its dual to produce symbol log-likelihood ratios (LLRs);
a bit LLR calculation module configured to calculate bit LLRs based on the symbol LLRs; and
a plurality of LDPC decoders configured to decode transmitted information using the bit LLRs.

18. The receiver of claim 17, wherein the points of the constellation correspond to the vertices of a dodecahedron and an icosahedron.

19. The receiver of claim 18, wherein the constellation is a 32-point hybrid subcarrier amplitude phase polarization modulation (H-SAPP) constellation.

20. The receiver of claim 17, wherein the demapper comprises a lookup table configured to convert between a Stokes representation and Cartesian/polar coordinates in two orthogonal polarizations.
